(19) United States
(12) Patent Application Publication
(10) Pub. No.: US 2015/0138211 A1
(43) Pub. Date: May 21, 2015

(54) Method and Device for Loading and Unloading Object Hierarchically in Three-Dimensional Virtual Reality Scene

(71) Applicant: Weifeng Ren, Beijing (CN)

(72) Inventor: Weifeng Ren, Beijing (CN)

(21) Appl. No.: 14/403,660

(22) PCT Filed: Sep. 12, 2012
(86) PCT No.: PCT/CN2012/001259

§ 371 Date: Nov. 25, 2014

(30) Foreign Application Priority Data
May 25, 2012 (CN) 201210167247.3

(51) Int. Cl. G06T 15/00; G06T 19/00

(52) U.S. Cl. CPC G06T 15/005; G06T 19/006
USPC 345/520

(57) ABSTRACT

A method for loading and unloading an object hierarchically in a three-dimensional virtual reality scene is provided; the method includes: after perceiving a behaviour of clicking and selecting one or more objects in a three-dimensional virtual reality scene, determining a hierarchical level of the object in a tree management structure and a corresponding node in the tree management structure; and after receiving a command of entering the next level, if there exists a next hierarchical level corresponding to the node, loading all objects in the next hierarchical level into the three-dimensional virtual reality scene, and unloading all objects in the hierarchical level where the object is located. A device for loading and unloading one or more objects hierarchically in a three-dimensional virtual reality scene is also provided.

### TECHNICAL FIELD

The disclosure relates to the field of three-dimensional virtual reality technology, and more particularly to a method and device for loading and unloading an object hierarchically in a three-dimensional virtual reality scene.

### BACKGROUND

Virtual reality technology has virtuality of transcending the reality. As a new computer technology developed with multimedia technology, the virtual reality technology uses three-dimensional image generation technology, multi-sensor interaction technology and high-definition display technology to generate a realistic three-dimensional virtual environment, and users may enter the virtual environment only through a special interaction device. The virtual reality technology promotes development of the computer technology greatly, and one of its main functions is generating a virtual reality scene. The virtual reality technology has been applied to industry, architectural design, educational training, cultural entertainment and other aspects, and its application and development are changing people's lives.

With the rapid development of computer image processing technology, users have a higher and higher requirement for display quality of the virtual reality scene. However, all the details of one or more objects can not be shown completely in a three-dimensional virtual reality scene, because using the virtual reality technology to completely show the details of all objects in a large scene not only occupies a large amount of computer memory, but also has a very high requirement for the Central Processing Unit (CPU) and the Graphics Processing Unit (GPU). Although the quality of picture displayed by the computer may be improved by showing all the details, the fluency of the displayed frame is reduced, and a hang (or freeze) of the computer even occurs in a running process.

### SUMMARY

In view of the above, the embodiments of the disclosure mainly provide a method and device for loading and unloading an object hierarchically in a three-dimensional virtual reality scene, which achieves the dynamically loading and unloading of one or more objects hierarchically in a three-dimensional virtual reality scene.

To this end, a method for loading and unloading an object hierarchically in a three-dimensional virtual reality scene provided by the disclosure includes:

after perceiving a behaviour of clicking and selecting one or more objects in a three-dimensional virtual reality scene, determining a hierarchical level of the object in a tree management structure and a corresponding node of the object in the tree management structure; and

after receiving a command of entering a next (or lower) level, if there exists a next hierarchical level corresponding to the node, loading all objects in the next hierarchical level into the three-dimensional virtual reality scene, and unloading all objects in the hierarchical level where the object is located.

Preferably, the method further includes:

after receiving a command of returning to a prior (or last, or upper) level, if there exists a prior hierarchical level corresponding to the node, loading all objects in the prior hierarchical level into the three-dimensional virtual reality scene, and unloading all objects in the hierarchical level where the object is located.

Preferably, the method further includes:

generating the tree management structure according to an affiliation and combination mode among all objects in the three-dimensional virtual reality scene.

Preferably, the step of generating the tree management structure according to the affiliation and combination modes of among all objects in the three-dimensional virtual reality scene in the above method includes:

making one or more first objects correspond to a root node of the tree management structure, wherein the root node is located in a first hierarchical level of the tree management structure, and the first object is the entire three-dimensional virtual reality scene;

if the first object consists of N parts, one or more second objects corresponding to each part of the first object belonging to a second hierarchical level of the tree management structure, wherein a node corresponding to the one or more second objects is a sub-node of the root node, N is an integer greater than 1;

if the second object consists of M parts, one or more third objects corresponding to each part of the second object belonging to a third hierarchical level of the tree management structure, wherein a node corresponding to the third object is a sub-node of the node corresponding to the second object, M is an integer greater than 1;

generating the next hierarchical levels according to the same manner, until the first object is decomposed to an actually demanded hierarchical level.

Preferably, the method further includes:

after receiving the command of entering the next level, if there does not exist the next hierarchical level corresponding to the node, sending a message of execution failure; and

after receiving the command of returning to the prior level, if there does not exist the prior hierarchical level corresponding to the node, sending the message of execution failure.

Preferably, in the method, the behaviour of clicking and selecting one or more objects in the three-dimensional virtual reality scene includes:

controlling a mouse to click and select one or more objects in the three-dimensional virtual reality scene; or when a display window is a touch screen, clicking and selecting the object by using a touch pen or a finger touch; or clicking and selecting the object by inputting instruction through a keyboard.

A device for loading and unloading one or more objects hierarchically in a three-dimensional virtual reality scene includes:

a hierarchical level determining unit configured to, after perceiving a behaviour of clicking and selecting one or more objects in a three-dimensional virtual reality scene, determine a hierarchical level of the object in a tree management structure and a corresponding node in the tree management structure;

a receiving unit configured to receive a command of entering a next level;

a determining unit configured to determine whether or not there exists a next hierarchical level corresponding to the node; and

a loading and unloading unit configured to, when the determining unit determines that there exists the next hierarchical level corresponding to the node, load all objects in the next hierarchical level into the three-dimensional virtual reality scene, and unload all objects in the hierarchical level where the object is located, after the receiving unit receives the command of entering the next level.

Preferably, in the device:

the receiving unit is further configured to receive a command of returning to a prior level;

the determining unit is further configured to determine whether there exists a prior hierarchical level corresponding to the node; and

the loading and unloading unit is further configured to, when the determining unit determines there exists the prior hierarchical level corresponding to the node, load all objects in the prior hierarchical level into the three-dimensional virtual reality scene, and unload all objects in the hierarchical level where the object is located, after the receiving unit receives the command of returning to the prior level.

Preferably, the device further includes:

a tree structure generating unit, configured to generate the tree management structure according to an affiliation and combination mode among all objects in the three-dimensional virtual reality scene.

Preferably, the device further includes:

a message unit, configured to send a message of execution failure when the determining unit determines that there does not exist the next hierarchical level corresponding to the node, after the receiving unit receives the command of entering the next level;

the message unit is further configured to send the message of execution failure when determining unit determines that there does not exist the prior hierarchical level corresponding to the node, after the receiving unit receives the command of returning to the prior level.

From this, the method and device for loading and unloading one or more objects hierarchically in a three-dimensional virtual reality scene provided by the disclosure achieve the aim of dynamically loading object hierarchical levels that a user needs to observe and unloading irrelevant hierarchical level resources, after determining a hierarchical level where a clicked and selected object is located in the three-dimensional virtual reality scene and a corresponding node of the clicked and selected object in the hierarchical level, when receiving a command of entering the next level or returning to the prior level, loading all objects in a next hierarchical level or a prior hierarchical level into the three-dimensional virtual reality scene, and unloading all objects in the hierarchical level where the clicked and selected object is located, thereby improving the fluency of display frame of the three-dimensional virtual reality scene while reducing a large amount of occupation of computer memory.

### BRIEF DESCRIPTION OF THE DRAWINGS

In order to more clearly illustrate the embodiments of the disclosure or technical schemes in the prior art, following simple introductions for the figures required to be used in the embodiments or descriptions in the prior art are made. Obviously, the figures described as follows are some of the embodiments of the disclosure, and common technicians in the field can obtain other figures according to these figures on the premise of no creative labor.

FIG. 1 is a schematic diagram of a tree management structure of the disclosure;

FIG. 2 is a flowchart of a first embodiment of a method for loading and unloading one or more objects hierarchically in a three-dimensional virtual reality scene of the disclosure;

FIG. 3 is a schematic diagram of loading and unloading one or more objects hierarchically in a three-dimensional virtual reality scene of the disclosure;

FIG. 4 is a flowchart of a second embodiment of a method for loading and unloading one or more objects hierarchically in a three-dimensional virtual reality scene of the disclosure;

FIG. 5 is a structure diagram of a first embodiment of a device for loading and unloading one or more objects hierarchically in a three-dimensional virtual reality scene of the disclosure; and

FIG. 6 is a structure diagram of a second embodiment of a device for loading and unloading one or more objects hierarchically in a three-dimensional virtual reality scene of the disclosure.

### DETAILED DESCRIPTION OF THE EMBODIMENTS

Objects in a three-dimensional virtual reality scene are divided into combined and single objects, the combined objects consist of a plurality of single objects, and a tree management structure may be constructed by defining affiliation and combination modes of the objects in the three-dimensional virtual reality scene. All nodes in the tree management structure are divided into the real nodes and the virtual nodes, wherein the real nodes are the leaf nodes of the tree management structure, and there exists the single objects in the three-dimensional virtual reality scene corresponding to the leaf nodes; however, the virtual nodes are all the nodes except the leaf nodes and correspond to the combinations in the three-dimensional virtual reality scene. Displaying of the combinations in the three-dimensional virtual reality scene depends on the combination mode of all the single objects constituting the combinations, and all the real nodes and the virtual nodes constitute the tree management structure according to hierarchy classification.

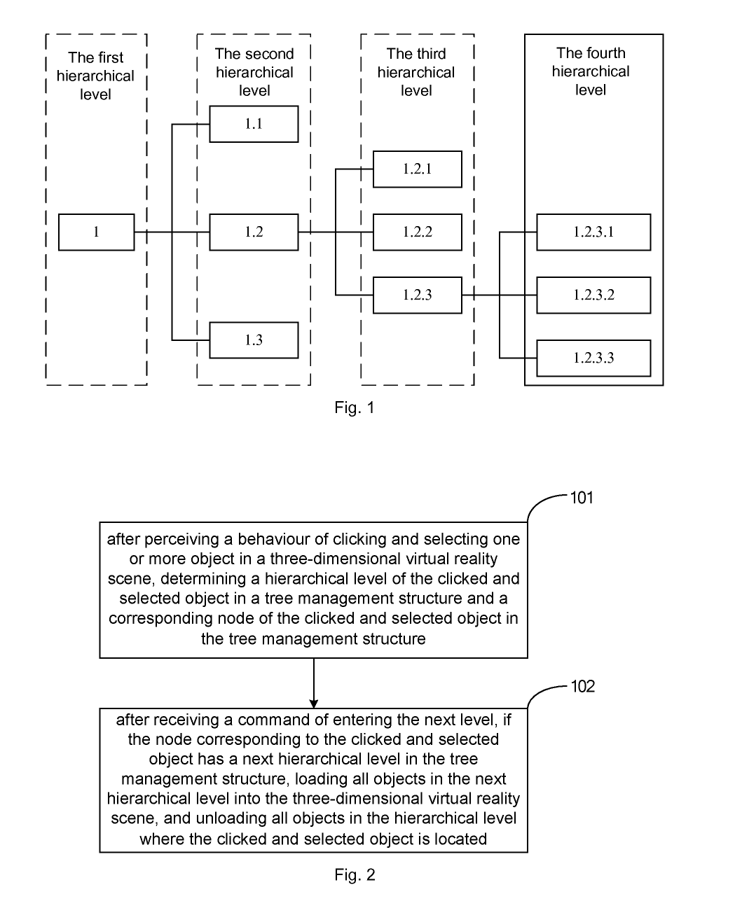

Illustrations are referred to a drawing showing the tree management structure displayed in FIG. 1. A first hierarchy includes a root node 1, and a second hierarchy includes child nodes 1.1, 1.2 and 1.3; a third hierarchy includes child nodes 1.2.1, 1.2.2 and 1.2.3; a fourth hierarchy includes child nodes 1.2.3.1, 1.2.3.2 and 1.2.3.3, wherein the root node 1 and the child nodes 1.2 and 1.2.3 are virtual nodes and there exists the combinations in three-dimensional virtual reality scene corresponding to the virtual nodes, and other nodes in three-dimensional virtual reality scene are real nodes and there exists the single objects in the three-dimensional virtual reality scene corresponding to the real nodes. The affiliation and combination modes of the objects are designed in the three-dimensional virtual reality scene so as to construct the tree management structure of the objects in the three-dimensional virtual reality scene.

To make the aims, technical schemes and advantages of the embodiments of the disclosure more clear, the technical schemes in the embodiments of the disclosure are clearly and completely described as follows according to the drawings in the embodiments of the disclosure. It can be seen that the described embodiments are part of the embodiments of the disclosure rather than all of the embodiments. Based on the embodiments of the disclosure, all the other embodiments obtained by those skilled in the art on the premise of no creative labor belong to the scope of protection of the disclosure.

As shown in FIG. 2, the first embodiment of a method for loading and unloading one or more objects hierarchically in a three-dimensional virtual reality scene of the disclosure includes the following steps.

S101: after perceiving a behaviour of clicking and selecting one or more objects in a three-dimensional virtual reality scene, determining a hierarchical level of the clicked and selected object in a tree management structure and a corresponding node of the clicked and selected object in the tree management structure.

In the embodiment, the behavior for clicking and selecting the object in the three-dimensional virtual reality scene includes but is not limited to the following three modes: first, controlling a mouse to click and select the object in the three-dimensional virtual reality scene; second, when the display window is a touch screen, clicking and selecting the object in the three-dimensional virtual reality scene through a touch pen or by a finger touch mode; third, clicking and selecting the object in the three-dimensional virtual reality scene by a mode of inputting the instruction through the keyboard.

After the behaviour of clicking and selecting one or more objects in a three-dimensional virtual reality scene is perceived, the object can be made correspond to a pre-generated tree management structure, so as to determine, according to the tree management structure, a hierarchical level to which the clicked and selected object belongs and a corresponding node of the clicked and selected object in the hierarchical level. The present solution generates the tree management structure according to an affiliation and combination mode of all objects in the three-dimensional virtual reality scene; that is, firstly, determining a root node according to an affiliation and combination mode of all objects in the three-dimensional virtual reality scene, and then, determining all sub-nodes of the root node, at prior, making up the tree management structure by the root node and all the sub-nodes, the specific steps are as follows: 1. making the first object correspond to the root node of the tree management structure, wherein the root node is located in the first hierarchical level of the tree management structure, and the first object is the whole three-dimensional virtual reality scene; 2. if the first object consists of N parts, the second object corresponding to each part of the first object belongs to the second hierarchical level of the tree management structure, and a node corresponding to the second object which corresponds to each part of the first object is a sub-node of the root node, wherein, N is an integer greater than 1; 3. if the second object consists of M parts, the third object corresponding to each part of the second object belongs to the third hierarchical level of the tree management structure, and a node corresponding to the third object is a sub-node of the node corresponding to the second object, wherein, M is an integer greater than 1; and so on, until the first object is decomposed to an actually demanded hierarchical level.

S102: after receiving a command of entering the next level, if the node corresponding to the clicked and selected object has a next hierarchical level in the tree management structure, loading all objects in the next hierarchical level into the three-dimensional virtual reality scene, and unloading all objects in the hierarchical level where the clicked and selected object is located.

In the present embodiment, the received command of entering the next level is input by a user, and implementation of inputting the command includes but is not limited to the following two ways: firstly. implementing by inputting the command through a keyboard; a certain character on the keyboard is made corresponding to the command, then clicking and selecting the character may enter the next hierarchical level of the tree management structure; secondly. if a display window is a touch screen, an operating button for entering the next hierarchical level may be set in the display window, and clicking and selecting the operating button by using a finger or a touch pen may input the command of entering the next level.

In the first embodiment, a hierarchical level where a clicked and selected object is located and a corresponding node of the clicked and selected object are determined by perceiving a behaviour of clicking and selecting, after a command of entering the next level was received, all objects in the hierarchical level where the clicked and selected object is located are unloaded, and all objects in a next hierarchical level of the node is loaded in the three-dimensional virtual reality scene, so that the aim of dynamically loading object hierarchical levels that a user needs to observe and unloading irrelevant hierarchical level resources is achieved, not only reducing consumption of computer, but also improving the fluency of display frame of the scene.

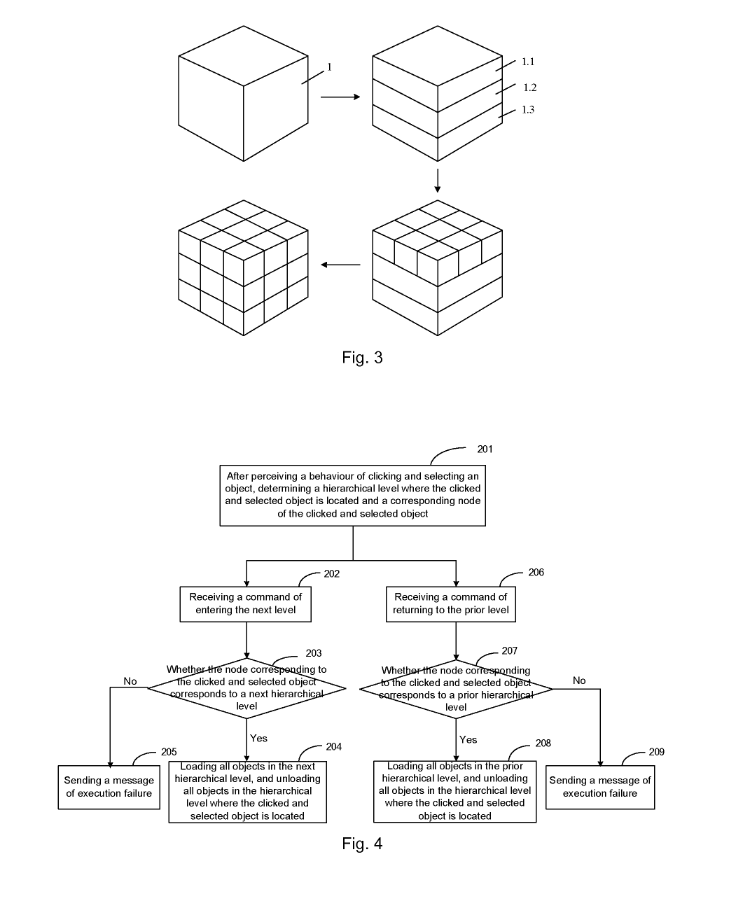

With reference to the schematic diagram of loading and unloading one or more objects hierarchically in a three-dimensional virtual reality scene shown in FIG. 3, the object is a Rubik's cube, node 1 corresponding to the object is the root node of the tree management structure, and the object corresponding to the node 1 consists of three parts, which respectively correspond to node 1.1, node 1.2 and node 1.3 in the tree management structure, and are in the second hierarchical level of the tree management structure, after entering the next level, the object corresponding to the node 1 may be unloaded, and the objects corresponding to the node 1.1, the node 1.2 and the node 1.3 are loaded, similarly, when entering the next hierarchical level of the node 1.1, 9 blocks of the Rubik's cube may be unfolded while unloading the object corresponding to the node 1.1, show of details of the whole Rubik's cube may be completed by entering the next hierarchical levels of the node 1.2 and the node 1.3 in order.

As shown in FIG. 4, the second embodiment of a method for loading and unloading one or more objects hierarchically in a three-dimensional virtual reality scene of the disclosure includes the following steps:

S201: after perceiving a behaviour of clicking and selecting one or more objects in a three-dimensional virtual reality scene, determining a hierarchical level of the clicked and selected object in the tree management structure and a corresponding node of the clicked and selected object in the tree management structure.

In the present embodiment, one or more objects in the three-dimensional virtual reality scene which is displayed on a two-dimensional screen may be clicked and selected through a mouse, the object corresponds to a node in the tree management structure, as shown in FIG. 1, for example, if the node corresponding to the clicked and selected object is node 1.2.3, the node is located in the third hierarchical level of the tree management structure, and the node is a virtual node, and the object corresponding to the node 1.2.3 is a combination.

S202: after receiving the command of entering the next level, executing S203 to S205;

S203: determining whether or not the node corresponding to the clicked and selected object corresponds to a next hierarchical level in the tree management structure, if so, executing S204; if not, executing S205.

S204: loading all objects in the next hierarchical level of the tree management structure into the three-dimensional virtual reality scene, and unloading all objects in the hierarchical level where the clicked and selected object is located.

As shown in FIG. 1, when the node corresponding to the clicked and selected object is the node 1.2.3, all objects in the hierarchical level to which the clicked and selected object belongs, namely the third hierarchical level, in the three-dimensional virtual reality scene are unloaded, that is, the objects corresponding to the node 1.2.1 and the node 1.2.2 and the node 1.2.3 in the third hierarchical level are unloaded, wherein the objects corresponding to the node 1.2.1 and the node 1.2.2 are single objects, the object corresponding to the node 1.2.3 is combination. All objects in the fourth hierarchical level are loaded while unloading all objects in the third hierarchical level, that is, the objects corresponding to the node 1.2.3.1 and the node 1.2.3.2 and the node 1.2.3.3 in the fourth hierarchical level are loaded, and all objects in the fourth hierarchical level are single objects.

S205: sending a message of execution failure to display the message of execution failure on a two-dimensional screen, indicating that the node corresponding to the clicked and selected object does not has a next hierarchical level.

S206: when receiving a command of returning the prior level, executing S207 to S209.

S207: determining whether the node corresponding to the clicked and selected object has a prior hierarchical level in the tree management structure, if so, executing S208; if not, executing S209.

S208: loading all objects in the prior hierarchical level of the tree management structure into the three-dimensional virtual reality scene, and unloading all objects in the hierarchical level where the clicked and selected object is located.

As shown in FIG. 1, when the node corresponding to the clicked and selected object is the node 1.2.3, all objects in the hierarchical level to which the clicked and selected object belongs, namely the third hierarchical level, in the three-dimensional virtual reality scene are unloaded; all objects in the second hierarchical level are loaded while unloading all objects in the third hierarchical level, that is, the objects corresponding to the node 1.1 and the node 1.2 and the node 1.3 in the second hierarchical level are loaded, wherein the objects corresponding to the node 1.1 and the node 1.3 are single objects, the object corresponding to the node 1.2 is combination.

209: sending a message of execution failure to display the message of execution failure on a two-dimensional screen, indicating that the node corresponding to the clicked and selected object does not correspond to a prior hierarchical level.

In the second embodiment, all objects in the prior hierarchical level and the next hierarchical level of the tree management structure are dynamically loaded according to user needs, and all objects in the hierarchical level where the clicked and selected object is located are unloaded, so that a concerned part of the object is displayed in detail without the need to display all details of the object, not only reducing consumption of computer, but also improving the fluency of display frame of the scene.

FIG. 5 is a structure diagram of a first embodiment of a device for loading and unloading one or more objects hierarchically in a three-dimensional virtual reality scene of the disclosure, the device includes: a hierarchical level determining unit 11, which is configured to, after perceiving a behaviour of clicking and selecting one or more objects in a three-dimensional virtual reality scene, determine a hierarchical level of the clicked and selected object in a tree management structure and a corresponding node of the clicked and selected object in the tree management structure; a receiving unit 12, which is configured to receive a command of entering the next level; a determining unit 13, which is configured to determine whether or not the node corresponding to the clicked and selected object has a next hierarchical level; and a loading and unloading unit 14, which is configured to, after the receiving unit received the command of entering the next level, when the node corresponding to the clicked and selected object determined by the determining unit has a next hierarchical level, load all objects in the next hierarchical level into the three-dimensional virtual reality scene, and unload all objects in the hierarchical level where the clicked and selected object is located.

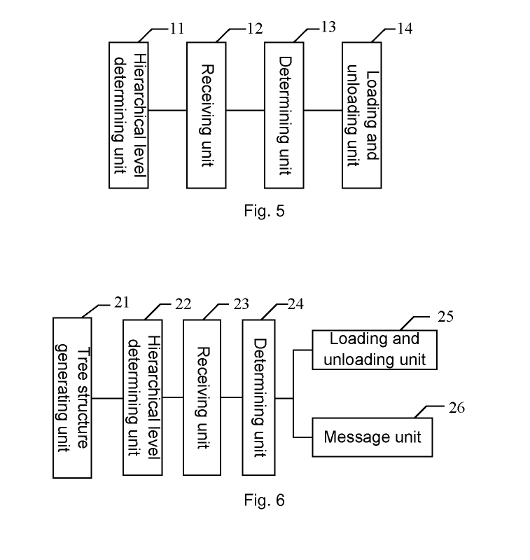

FIG. 6 is a structure diagram of a second embodiment of a device for loading and unloading one or more objects hierarchically in a three-dimensional virtual reality scene of the disclosure; the device includes: a tree structure generating unit 21, which is configured to generate a tree management structure according to an affiliation and combination mode of all objects in the three-dimensional virtual reality scene; a hierarchical level determining unit 22, which is configured to, after perceiving a behaviour of clicking and selecting one or more objects in a three-dimensional virtual reality scene, determine a hierarchical level of the clicked and selected object in the tree management structure and a corresponding node of the clicked and selected object in the tree management structure; a receiving unit 23, which is configured to receive a command of entering the next level; the receiving unit 23 is further configured to receive a command of returning to the prior level; a determining unit 24, which is configured to determine whether the node corresponding to the clicked and selected object corresponds to a next hierarchical level; the determining unit 24 is further configured to determine whether the node corresponding to the clicked and selected object has a prior hierarchical level; a loading and unloading unit 25, which is configured to, after the receiving unit received the command of entering the next level, when the node corresponding to the clicked and selected object determined by the determining unit has a next hierarchical level, load all objects in the next hierarchical level into the three-dimensional virtual reality scene, and unload all objects in the hierarchical level where the clicked and selected object is located; the loading and unloading unit 25 is further configured to, after the receiving unit received the command of returning to the prior level, when the node corresponding to the clicked and selected object determined by the determining unit corresponds to a prior hierarchical level, load all objects in the prior hierarchical level into the three-dimensional virtual reality scene, and unload all objects in the hierarchical level where the clicked and selected object is located; a message unit 26, which is configured to, after the receiving unit received the command of entering the next level, when the node corresponding to the clicked and selected object determined by the determining unit has a next hierarchical level, send a message of execution failure; the message unit 26 is further configured to, after the receiving unit received the command of returning to the prior level, when the node corresponding to the clicked and selected object determined by the determining unit has a prior hierarchical level, send a message of execution failure.

The device for loading and unloading one or more objects hierarchically in a three-dimensional virtual reality scene may determine, through the hierarchical level determining unit, a hierarchical level where the clicked and selected object is located and a corresponding node of the clicked and selected object in the hierarchical level; after the receiving unit received the command of entering the next level or the command of returning to the prior level, when the determining unit determines that there is a next hierarchical level or a prior hierarchical level, all objects in the next hierarchical level or the prior hierarchical level are loaded and all objects in the hierarchical level where the clicked and selected object is located are unloaded by using the loading and unloading unit, so that a concerned part of the object is displayed in detail without the need to display all details of the object, improving the fluency of display frame while reducing a large amount of occupation of computer resources.

In addition, if the internal structure of a certain object in the three-dimensional virtual reality scene is not clear now, but with the development of things, the internal structure of the object has been clear, and it is needed to present it in the three-dimensional virtual reality scene, it is feasible to extend in the original tree structure without the need to adjust the original whole three-dimensional virtual reality scene.

Each embodiment in the description is described progressively; each embodiment focuses on the differences from other embodiments, and the same and similar parts of these embodiments may refer to each other. For system or device disclosed in the embodiment, because it corresponds to the method disclosed in the embodiment, it is described simply, and the related part may refer to description of the method.

It should be noted that in the text, relation terms such as a first class and a second class are only used for distinguishing one entity or operation from another entity or operation rather than requiring or implying that such any actual relations or sequences between these entities or operations. In addition, the terms ‘include’, ‘contain’ or any other variants meaning to cover non-exclusive inclusions, so that a process, a method, one or more objects or equipment which includes a series of factors not only includes these factors, but also includes other factors which are not specifically listed, or includes factors which are fixed to the process, the method, the object or the equipment. Under a condition of no more limitations, the factor limited by a sentence ‘including a . . . ’ is not excluded that other identical factors still exist in the process, the method, the object or the equipment including the factors.

The above are only the preferred embodiments of the disclosure, and are not intended to limit the scope of protection of the disclosure. Any modifications, equivalent replacements, improvements and the like which are performed within the spirit and the principle of the disclosure are included in the scope of protection of the disclosure.

What is claimed is:

1. A method for loading and unloading an object hierarchically in a three-dimensional virtual reality scene, comprising:
after perceiving a behaviour of clicking and selecting one or more objects in a three-dimensional virtual reality scene, determining a hierarchical level of the object in a tree management structure and a corresponding node of the object in the tree management structure; and
after receiving a command of entering a next level, if there exists a next hierarchical level corresponding to the node, loading all objects in the next hierarchical level into the three-dimensional virtual reality scene, and unloading all objects in the hierarchical level where the object is located.

2. The method according to claim 1, the method further comprising:
after receiving a command of returning to a prior level, if there exists a prior hierarchical level corresponding to the node, loading all objects in the prior hierarchical level into the three-dimensional virtual reality scene, and unloading all objects in the hierarchical level where the object is located.

3. The method according to claim 1, the method further comprising:
generating the tree management structure according to an affiliation and combination mode among all objects in the three-dimensional virtual reality scene.

4. The method according to claim 3, wherein generating the tree management structure according to the affiliation and combination mode among all objects in the three-dimensional virtual reality scene comprises:
making one or more first objects correspond to a root node of the tree management structure, wherein the root node is located in a first hierarchical level of the tree management structure, and the first object is the entire three-dimensional virtual reality scene;
if the first object consists of N parts, one or more second objects corresponding to each part of the first object belonging to a second hierarchical level of the tree management structure, wherein a node corresponding to the second object is a sub-node of the root node, N is an integer greater than 1;
if the second object consists of M parts, one or more third objects corresponding to each part of the second object belonging to a third hierarchical level of the tree management structure, wherein a node corresponding to the third object is a sub-node of the node corresponding to the second object, M is an integer greater than 1;
generating the next hierarchical levels according to the same manner, until the first object is decomposed to an actually demanded hierarchical level.

5. The method according to claim 2, the method further comprising:
after receiving the command of entering the next level, if there does not exist the next hierarchical level corresponding to the node, sending a message of execution failure; and
after receiving the command of returning to the prior level, if there does not exist the prior hierarchical level corresponding to the node, sending the message of execution failure.

6. The method according to claim 1, wherein the behaviour of clicking and selecting the object in the three-dimensional virtual reality scene comprises:
controlling a mouse to click and select one or more objects in the three-dimensional virtual reality scene; or when a display window is a touch screen, clicking and selecting the object by using a touch pen or a finger touch; or clicking and selecting the object by inputting instruction through a keyboard.

7. A device for loading and unloading an object hierarchically in a three-dimensional virtual reality scene, comprising:
a hierarchical level determining unit configured to, after perceiving a behaviour of clicking and selecting one or more objects in a three-dimensional virtual reality scene, determine a hierarchical level of the object in a tree management structure and a corresponding node in the tree management structure;
a receiving unit configured to receive a command of entering a next level;
a determining unit configured to determine whether or not there exists a next hierarchical level corresponding to the node; and
a loading and unloading unit configured to, when the determining unit determines that there exists the next hierarchical level corresponding to the node, load all objects in the next hierarchical level into the three-dimensional virtual reality scene, and unload all objects in the hierarchical level where the object is located, after the receiving unit receives the command of entering the next level.

8. The device according to claim 7, the device further comprising:
the receiving unit is further configured to receive a command of returning to a prior level;
the determining unit is further configured to determine whether there exists a prior hierarchical level corresponding to the node; and
the loading and unloading unit is further configured to, when the determining unit determines there exists the prior hierarchical level corresponding to the node, load all objects in the prior hierarchical level into the three-dimensional virtual reality scene, and unload all objects in the hierarchical level where the object is located, after the receiving unit receives the command of returning to the prior level.

9. The device according to claim 8, the device further comprising:
A tree structure generating unit, configured to generate the tree management structure according to an affiliation and combination mode among all objects in the three-dimensional virtual reality scene.

10. The device according to claim 8, the device further comprising:
a message unit, configured to send a message of execution failure when the determining unit determines that there does not exist the next hierarchical level corresponding to the node, after the receiving unit receives the command of entering the next level;
the message unit is further configured to send the message of execution failure when determining unit determines that there does not exist the prior hierarchical level corresponding to the node, after the receiving unit receives the command of returning to the prior level.
